(19) United States
(12) Patent Application Publication
(10) Pub. No.: US 2011/0165212 A1
(43) Pub. Date: Jul. 7, 2011

(54) Nano antimicrobial personal protection gear

(75) Inventor: Kia Chee Chiam, Singapore (SG)

(73) Assignee: I-NANO INDUSTRIES PTE LTD, Singapore (SG)

(21) Appl. No.: 12/806,471

(22) Filed: Aug. 13, 2010

(30) Foreign Application Priority Data
Jan. 7, 2010 (SG) 201004728-0

(51) Int. Cl. A01N 25/34; A01P 1/00

(52) U.S. Cl. 424/404

(57) ABSTRACT

An antimicrobial protection gear for use by a person, the an antimicrobial protection gear comprising a 1^{st} outer layer of woven/non-woven material treated with anti-microbial agent; and a 2^{nd} inner layer of woven/non-woven material treated with anti-microbial agent. When a person coughs, the saliva, droplets and other body fluids ejected by the person is captured into the 1^{st} outer layer, bacteria, viruses and micro-organisms in the said saliva, droplets and other body fluids are sterilized by the anti-microbial in the 1^{st} outer layer, said saliva, droplets and other body fluids then absorbed into the 2^{nd} inner layer, and all the bacteria, viruses and micro-organisms sterilized and trapped inside the 2^{nd} inner layer and removed by washing.

A 3^{rd} layer or more layers can be included in the clothing accessory.

### FIELD OF THE INVENTION

The present invention is an antimicrobial personal protection gear comprising multi-layers of woven/non-woven material which is made to be a piece of cloth accessory such as a towel, wrist band, head band, handkerchief, a bandana and the like.

### BACKGROUND OF THE INVENTION

During coughing, snivelling or yawning actions of people, millions of bacteria/virus/microorganism will be ejected from a human's mouth and transferred to the surrounding air and also resulting in cross contamination. A face mask may be used but there are many occasions when a person finds it inconvenient to use a face mask. Sometimes a person may forget to use a face mask. This is more so for children who find such face mask inconvenient or troublesome to wear.

What is desired is an antimicrobial protection gear which can be used to contain the millions of bacteria/virus/microorganisms ejected from a person's mouth. Such an protection gear must not only trap and capture the bacteria/virus/micro-organisms but sterilizes them so as to prevent their growth and further cross contamination. Such an antimicrobial protection gear must also have sufficient capacity to trap and capture bacteria/virus/micro-organisms ejected from a person in the course of a day. What is more desirable is an antimicrobial protection gear which also sterilizes the bacteria/virus/micro-organisms so as to render the bacteria/virus/micro-organisms harmless while trapped inside the protection gear.

This problem of capturing and sterilizing bacteria/virus/micro-organisms ejected from a person is solved by the use of an antimicrobial protection gear which has a layer of super absorption fabric/non-woven thin layer to absorb bacteria/virus/micro-organisms ejected from a person and a second layer to quickly absorb, capture and sterilize the bacteria/virus/micro-organisms, thus rendering the bacteria/virus/micro-organisms harmless. A third layer may be necessary so that the person can feel comfortable and does not come into contact with the sterilized bacteria/virus/micro-organisms trapped in the second layer.

### SUMMARY OF THE INVENTION

A first object of the invention is a an antimicrobial protection gear for use by a person, the an antimicrobial protection gear comprising:—
a 1^{st} outer layer of woven/non-woven material treated with Anti-microbial agent; and
a 2^{nd} inner layer of woven/non-woven material treated with different Anti-microbial agent;
   such that when a person coughs, the saliva, droplets and other body fluids ejected by the person is captured into the 1^{st} outer layer, bacteria/viruses/micro-organisms in the said saliva, droplets and other body fluids are sterilized by the anti-microbial agent in the 1^{st} outer layer, said volume exceeding saliva, droplets and other body fluids then absorbed into the 2^{nd} inner layer, and all the bacteria, viruses and micro-organisms sterilized and trapped inside the 2^{nd} inner layer which can be removed by washing

A second object of the invention is an antimicrobial protection gear for use by a person, the an antimicrobial protection gear comprising:—
a 1^{st} outer layer of woven/non-woven material treated with Anti-microbial agent;
a 2^{nd} inner layer of woven/non-woven material treated with anti-microbial agent; and
a 3^{rd} layer of woven/non-woven material treated with anti-microbial agent;
   such that when a person coughs, the saliva, droplets and other body fluids ejected by the person is captured into the 1^{st} outer layer and 3^{rd} layer, bacteria/viruses/micro-organisms in the said saliva, droplets and other body fluids are sterilized by the anti-microbial agent in the 1^{st} outer layer and 3^{rd} layer, said volume exceeding saliva, droplets and other body fluids then absorbed into the 2^{nd} inner layer, and all the bacteria, viruses and micro-organisms sterilized and trapped inside the 2^{nd} inner layer.

Preferably the an antimicrobial protection gear is a handkerchief, a towel, a wristband, a head band, a scarf or a bandana.

Preferably, the 1^{st} outer layer, 2^{nd} inner layer and 3^{rd} layer of the an antimicrobial protection gear uses different types of anti-microbial agents.

### BRIEF DESCRIPTION OF THE DRAWINGS

For a better understanding of the invention, its advantages, and the objects attained by its use, reference should now be made to the accompanying drawings. The accompanying drawings illustrate one or more embodiments of the invention and together with the description herein, serve to explain the workings and principles of the invention.

FIG. 1 shows a first/third embodiment of the clothing accessory.

FIG. 2 shows a second embodiment of the clothing accessory.

### DETAILED DESCRIPTION OF THE INVENTION

The proposed invention described herein refers an antimicrobial protection gear such as a towel, wrist band, head band, handkerchief. The antimicrobial protection gear comprises of 2 or 3 or more layers of woven/non-woven material.

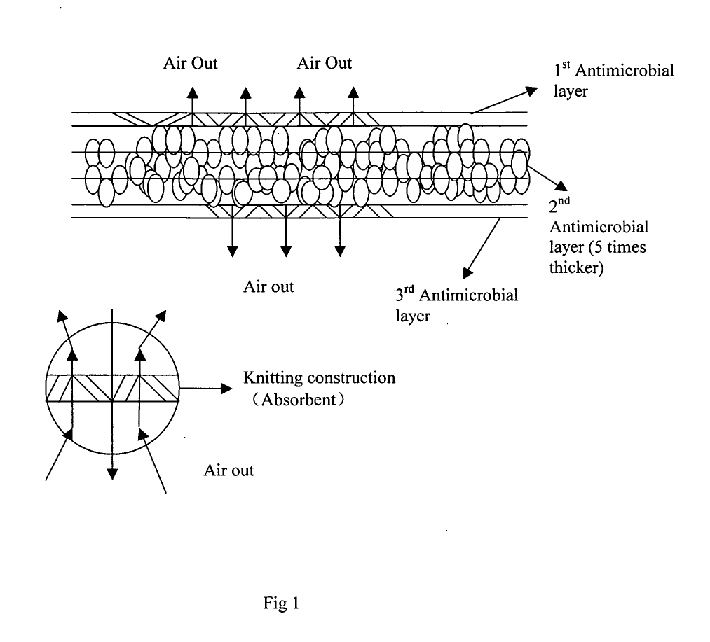

FIG. 1 shows a first/third embodiment of the protection gear.

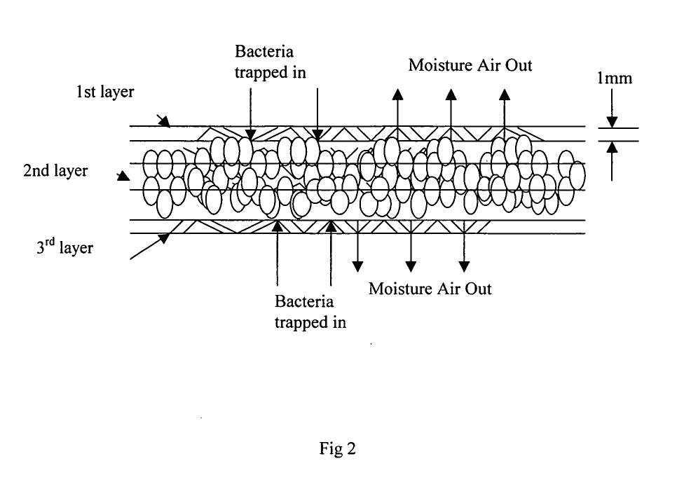

FIG. 2 shows a second embodiment of the protection gear.

Description of the invention is made by referring to FIG. 1. The inventive product comprises a 2 or 3 layer woven/non-woven material manufactured to form an antimicrobial protection gear such as a hand towel, handkerchief, towel, wrist band, head band, bandana, scarf and the like.

For the 1^{st} outer layer, the material used is a super absorption fabric/non-woven thin layer treated with anti-microbial agent which allows the 1^{st} layer to sterilize bacteria, viruses and micro-organism to 99.99%. The 1^{st} layer also has a property of super absorption, hence any saliva or droplets from sneezing or a running nose can be captured, absorbed and transferred to the 2^{nd} layer. In this manner, the 1^{st} outer layer is always kept dry and even after several times of use, the 1^{st} outer layer quick dries and remain dry. The quick absorbent properties of the 1^{st} layer is to ensure the bacteria, viruses and micro-organisms in the saliva, droplets and body fluids, if not sterilized by the anti-microbial agents in the 1^{st} layer do not remain in the 1^{st} layer, thus posing a danger of contamination to other persons. By quickly transferring the saliva, droplets and body fluids into the 2^{nd} layer, the 1^{st} layer will not be moist which promotes growth of bacteria, viruses and micro-organisms. Thus the 1^{st} outer layer will not allow any bacteria, viruses and micro-organism to grow in the moist fibres of the 1^{st} outer layer again, posing a danger of contamination to other persons.

The 2^{nd} inner layer is a thick hairy of woven/nano fabric/micro fabric which possesses super absorption capacity. The 2^{nd} inner layer can hold, retain and trap and sterilize almost all the bacteria/virus and micro-organisms as these are absorbed from the 1^{st} outer layer. In this manner, 99.99% of the bacteria/virus/micro-organisms are sterilized, and thus sterilized. By quickly absorbing the saliva and other fluids of the user, the 2^{nd} inner layer also help to dry the 1^{st} outer layer. It capacity is 5 times more than 1^{st} layer.

The 3^{rd} layer has the same features as the 1^{st} outer layer. The material used is a super absorption fabric/non-woven thin layer treated with anti-microbial properties which allows the 3^{rd} layer to sterilize bacteria and micro-organism to 99.99%. The 3^{rd} layer also has property of super absorption, hence any saliva or droplets from sneezing or a running nose can also be captured, absorbed and transferred to the 2^{nd} layer. In this manner, the 3^{rd} layer is always kept dry and even after several times of use, the 3^{rd} layer quick dries and remain dry. In this manner, the 3^{rd} layer is always kept dry and even after several times of use, the 3^{rd} layer quick dries and remain dry. The 3^{rd} layer which is super absorption can make the wearer feel comfortable since it can absorb most of the sweat when wearing, also transfer of heat out of the user's body.

The 3^{rd} layer is therefore useful when the antimicrobial protection gear used is a handkerchief as either the 1^{st} outer layer or the 3^{rd} layer can be used when a person is coughing into the protection gear.

The 3^{rd} layer may not be used when the antimicrobial protection gear is used in the form of a wrist band. When a user coughs into the wrist band, only the 1^{st} outer layer is used to cover the user's mouth. Thus the bacteria/virus and microorganisms are coughed into and captured onto the 1^{st} outer layer. The bacteria/virus and microorganisms are then quickly absorbed into the 2^{nd} inner layer where almost all the bacteria/virus and microorganisms are sterilized and stay trapped inside the 2^{nd} inner layer.

This inventive product is useful since in the course of coughing, snivelling or yawning, millions of bacteria/virus/micro-organism will be ejected from a person's mouth. In the case of children, when coughing, the inventive product in the form of a wrist band can serve to capture and sterilize all bacteria/virus/micro-organisms ejected from a child's mouth (during sneezing or coughing) or running the child's nose (for running nose). The inventive product can take the place of a face mask if not worn. With is unique design, all body fluids will be absorbed and absorbed into the 1^{st} layer and into the 2^{nd} inner layer. The use of this inventive product significantly reduces the risk of contamination to other persons.

This unique design can be used as wrist band, head band, towel, sporting, bandana, scarf and the like for use by both children and adults.

Although two embodiments have been described, it should be apparent, therefore that various modifications, rearrangements, substitutions alterations and adaptations to those embodiments may occur to persons sterilized in the art with the attainment of some or all of the advantages of the present invention. Accordingly, it should be clearly understood that the present invention is not intended to be limited by the particular features and structures hereinbefore described and depicted in the accompanying drawings. It is therefore intended to cover all such modifications, alterations and adaptations without departing from the scope and spirit of the present invention as defined by the appended claims.

### ADVANTAGEOUS EFFECTS OF THE INVENTION

This inventive product which is in the form of a wrist band, handkerchief, head band, towel, sporting, bandana, scarf and the like can be used by both children and adults, in the event a face mask is not used, either due to forgetfulness of the user or because a face mask is more restrictive to the user. A user can continue to use the inventive product without fear of further contamination or cross contamination since the 1^{st} outer layer and 3^{rd} layer is kept dry and sterilised and can be removed by washing.

1. An antimicrobial protection gear for use by a person, the antimicrobial protection gear comprising:—
a 1^{st} outer layer of woven/non-woven material treated with anti-microbial agent; and
a 2nd inner layer of woven/non-woven material treated with anti-microbial agent;
wherein when the person coughs, the saliva, droplets and other body fluids ejected by the person is captured into the 1st outer layer, bacteria/viruses/micro-organisms in the said saliva, droplets and other body fluids are sterilized by the anti-microbial in the 1st outer layer, said saliva, droplets and other body fluids then absorbed into the 2nd inner layer, and all the bacteria, viruses and micro-organisms sterilized and trapped inside the 2nd inner layer.

2. An antimicrobial protection gear for use by a person, the antimicrobial protection gear comprising:—
a 1st outer layer of woven/non-woven material treated with anti-microbial agent;
a 2nd inner layer of woven/non-woven material treated with Anti-microbial agent; and
a 3rd layer of woven/non-woven material treated with anti-microbial agent;
wherein when the person coughs, the saliva, droplets and other body fluids ejected by the person is captured into the 1st outer layer and 3rd layer, bacteria/viruses/micro-organisms in the said saliva, droplets and other body fluids are sterilized by the anti-microbial agent in the 1st outer layer and 3rd layer, said saliva, droplets and other body fluids then absorbed into the 2nd inner layer, and all the bacteria, viruses and micro-organisms sterilized and trapped inside the 2nd inner layer.

3. An antimicrobial protection gear as claimed in claim 1 which is a handkerchief, a towel, a wristband, a head band or a bandana.

4. An antimicrobial protection gear as claimed in claim 1 wherein the anti-microbial agent used in the 1st outer layer, 2nd inner layer and 3rd layer are different types of anti-microbial agents and different material.
